(19) United States
(12) Patent Application Publication
(10) Pub. No.: US 2024/0396005 A1
(43) Pub. Date: Nov. 28, 2024

(54) POSITIVE ELECTRODE ACTIVE MATERIAL FOR LITHIUM SECONDARY BATTERY, POSITIVE ELECTRODE FOR LITHIUM SECONDARY BATTERY, LITHIUM SECONDARY BATTERY, AND METHOD FOR PRODUCING POSITIVE ELECTRODE ACTIVE MATERIAL FOR LITHIUM SECONDARY BATTERY

(71) Applicant: SUMITOMO CHEMICAL COMPANY , LIMITED, Tokyo (JP)

(72) Inventors: Marie TAKIGUCHI, Osaka-shi (JP); Masashi INOUE, Niihama-shi (JP)

(73) Assignee: SUMITOMO CHEMICAL COMPANY , LIMITED, Tokyo (JP)

(21) Appl. No.: 18/696,146

(22) PCT Filed: Sep. 30, 2022
(86) PCT No.: PCT/JP2022/036747

§ 371 Date: Mar. 27, 2024

(30) Foreign Application Priority Data
Oct. 1, 2021 (JP) 2021-162937

(51) Int. Cl. H01M 4/04; H01M 4/02; H01M 4/36; H01M 4/505; H01M 4/525; H01M 4/58; H01M 10/0525

(52) U.S. Cl. CPC H01M 4/0471; H01M 4/366; H01M 4/505; H01M 4/525; H01M 4/5825; H01M 10/0525; H01M 2004/021; H01M 2004/028

(57) ABSTRACT

A positive electrode active material for a lithium secondary battery that can improve the cycle characteristic and discharge rate characteristic of the lithium secondary battery is provided. According to an embodiment of the present invention, the positive electrode active material for the lithium secondary battery has a layered structure, and contains a particle of a lithium metal composite oxide containing Li, Ni, and a specific element X, the particle contains a secondary particle which is an aggregate of primary particles, and containing a phosphorus element on the surface or on the surface and inside of the secondary particle, a value of XPS(P)/XPS(Li) is more than 0 and less than 0.2, a peak is present at 2θ=21 to 25° in a powder X-ray diffraction pattern, and an amount of lithium eluted obtained by a neutralization titration method is less than 0.20 wt %.

### TECHNICAL FIELD

The present invention relates to a positive electrode active material for a lithium secondary battery, a positive electrode for a lithium secondary battery, and a lithium secondary battery, and a method for producing a positive electrode active material for a lithium secondary battery.

### BACKGROUND ART

Lithium metal composite oxides are used as a matrix for positive electrode active materials for lithium secondary batteries. Known techniques related to lithium metal composite oxides or positive electrode active materials for lithium secondary batteries include, for example, the following techniques. Patent Literature 1 discloses a positive electrode active material that is a lithium composite oxide containing the largest amount of nickel among the constituent metal elements excluding lithium and having a phosphorus compound in the vicinity of its surface.

Patent Literature 2 discloses a positive electrode active material including coated lithium-nickel composite oxide particles that are obtained by treating lithium-nickel composite oxide particles with a phosphate compound.

### CITATION LIST

### Patent Literatures

[Patent Literature 1] JP2008-251434A
[Patent Literature 2] JP2016-143527A

### SUMMARY OF INVENTION

### Technical Problems

However, the aforementioned conventional techniques have room for improvement for achieving a positive electrode active material for a lithium secondary battery in which a cycle characteristic and discharge rate characteristic of the lithium secondary battery can be improved.

It is an object of one aspect of the present invention to achieve a positive electrode active material for a lithium secondary battery in which the cycle characteristic and discharge rate characteristic of the lithium secondary battery can be improved.

### Solution to Problems

The present invention includes the following aspects.

<1> A positive electrode active material for a lithium secondary battery having a layered structure, containing a particle of a lithium metal composite oxide containing at least Li, Ni, and an element X, in which the particle contains a secondary particle which is an aggregate of primary particles and contains a phosphorus element on the surface or on the surface and inside of the secondary particle,
the element X is one or more elements selected from the group consisting of Co, Mn, Fe, Cu, Ti, Mg, Ca, Al, W, Mo, Nb, Zn, Sn, Zr, Ga, V, B, and Si, and
requirements (1), (2), and (3) below are satisfied.
requirement (1): a value of XPS(P)/XPS(Li) is more than 0 and 0.15 or less (Here, XPS(P) represents an abundance ratio [at %] of the phosphorus element obtained from a P2p spectrum measured by X-ray photoelectron spectroscopy, and XPS(Li) represents an abundance ratio [at %] of Li obtained from a Li1s spectrum measured by X-ray photoelectron spectroscopy.)
requirement (2): a peak attributed to lithium phosphate is present at 2θ=21 to 250 in a powder X-ray diffraction pattern obtained by powder X-ray diffraction measurement.
requirement (3): an amount of lithium eluted obtained by a neutralization titration method is less than 0.20 wt %.
   <2> The positive electrode active material for the lithium secondary battery according to <1>, in which in the powder X-ray diffraction pattern,
the peak attributed to lithium phosphate contains a peak present at 2θ=22.5±10, and
a height H(α) of the peak present at 2θ=22.5±1° and a height H(β) of a peak present at 2θ=18.5±1° satisfy a relationship of 0.003≤H(α)/H(β)≤0.03.
   <3> The positive electrode active material for the lithium secondary battery according to <1> or <2>, in which a molar ratio of Li, Ni, the element X, and the phosphorus element satisfies a formula (1) below.

$$Li : Ni : X : P = a : ( 1 - b ) : b : c \qquad ( 1 )$$

(In the formula (1), a, b, and c satisfy 0.90≤a≤1.2, 0≤b≤0.7, and 0.003≤c≤0.03.)

<4> The positive electrode active material for the lithium secondary battery according to <3>, in which b in the formula (1) is 0 or more and 0.3 or less.
<5> The positive electrode active material for the lithium secondary battery according to any one of Claims <1> to <4>, in which a 50% cumulative volume particle diameter D₅₀ is 5 μm or more and 20 μm or less.
<6> The positive electrode active material for the lithium secondary battery according to any one of <1> to <5>, containing a sulfate anion, in which
a value of XPS(P)/XPS(S) is more than 0 and 2.0 or less.

(Here, XPS(P) represents an abundance ratio [at %] of the phosphorus element, and XPS(S) represents an abundance ratio [at %] of the sulfur element obtained from a S2p spectrum measured by X-ray photoelectron spectroscopy.)

<7> The positive electrode active material for the lithium secondary battery according to any one of <1> to <6>, in which the value of XPS(P)/XPS(Li) is more than 0 and less than 0.1.
<8> A positive electrode for a lithium secondary battery, containing: the positive electrode active material for the lithium secondary battery according to any one of <1> to <7>.
<9> A lithium secondary battery containing: the positive electrode for the lithium secondary battery according to <8>.
<10> A method for producing a positive electrode active material for a lithium secondary battery, including:
a first mixing step of mixing a metal composite compound containing Ni and an element X with a lithium compound to obtain a first mixture;
a first calcining step of calcining the first mixture in an oxygen-containing atmosphere to obtain a lithium metal composite oxide;
a second mixing step of mixing the lithium metal composite oxide and a phosphate so that a molar ratio of Ni and the element X contained in the lithium metal composite oxide and P contained in the phosphate satisfies a formula (2) below to obtain a second mixture,

$$Ni : X : P = ( 1 - b ) : b : c \qquad ( 2 )$$

(in the formula (2), b and c satisfy 0≤b≤0.7 and 0.003≤c≤0.03); and
a second calcining step of calcining the second mixture in an oxygen-containing atmosphere, in which
the element X is one or more elements selected from the group consisting of Co, Mn, Fe, Cu, Ti, Mg, Ca, Al, W, Mo, Nb, Zn, Sn, Zr, Ga, V, B, and Si,
a highest holding temperature T₁ in the first calcining step is 500° C. or more and 750° C. or less, and
a highest holding temperature T₂ in the second calcining step is 650° C. or more and 900° C. or less.
   <11> The method for producing the positive electrode active material for the lithium secondary battery according to <10>, in which the second mixture contains 1 wt % or more and 15 wt % or less of water relative to the total weight of the second mixture.
   <12> The method for producing the positive electrode active material for the lithium secondary battery according to <10> or <11>, in which a BET specific surface area of the phosphate is 0.1 m²/g or more and 10 m²/g or less.
   <13> The method for producing the positive electrode active material for the lithium secondary battery according to any one of <10> to <12>, in which
an anionic species of the phosphate is any one selected from the group consisting of PO₄³⁻, HPO₄²⁻, and H₂PO₄⁻, and
a cationic species of the phosphate is one or more selected from the group consisting of Al, Mg, Ca, NH₄, Co, Mn, Ti, and Zr.
   <14> The method for producing the positive electrode active material for the lithium secondary battery according to any one of <10> to <13>, in which a value of T₂−T₁ that is a difference between the highest holding temperature T₁ in the first calcining step and the highest holding temperature T₂ in the second calcining step is 20° C. or more and 250° C. or less.
   <15> The method for producing the positive electrode active material for the lithium secondary battery according to any one of <10> to <14>, in which the metal composite compound contains 500 ppm or more and 10000 ppm or less of a sulfate anion relative to the total weight of the metal composite compound.

### Advantageous Effect of Invention

An aspect of the present invention can provide a positive electrode active material for a lithium secondary battery that can improve the cycle characteristic and discharge rate characteristic of lithium secondary batteries.

### BRIEF DESCRIPTION OF DRAWINGS

FIG. 1 is a schematic view showing an example of a lithium secondary battery.

FIG. 2 is a schematic view showing an example of an all-solid-state lithium secondary battery.

FIG. 3 is an XRD profile obtained by powder X-ray diffraction of the lithium metal composite oxide produced in Example 1.

FIG. 4 is an XRD profile at 2θ=20 to 300 obtained by powder X-ray diffraction of the lithium metal composite oxide produced in Example 1.

FIG. 5 is an XRD profile obtained by powder X-ray diffraction of the lithium metal composite oxide produced in Comparative Example 1.

FIG. 6 is an XRD profile at 2θ=20 to 30° obtained by powder X-ray diffraction of the lithium metal composite oxide produced in Comparative Example 1.

### DESCRIPTION OF EMBODIMENTS

An embodiment of the present invention will be described below, but the present invention is not limited to this embodiment. In this description, “A to B” representing a numerical range means “A or more and B or less”, unless otherwise specified.

In the present description, Ni refers to the nickel element, not nickel metal, and Co, Al, Li and the like also refer to the cobalt element, aluminum element, lithium element, and the like, respectively.

In the present description, a lithium metal composite oxide may be referred to as LiMO, and a positive electrode active material for a lithium secondary battery may be referred to as CAM as an abbreviation for a cathode active material for a lithium secondary battery. A positive electrode for a lithium secondary battery may be referred to simply as “positive electrode”.

### [1. Positive Electrode Active Material for Lithium Secondary Battery]

The positive electrode active material for a lithium secondary battery (CAM) according to an embodiment of the present invention has a layered structure, and contains a particle of a lithium metal composite oxide containing at least Li, Ni, and an element X, the particle contains a secondary particle which is an aggregate of primary particles and contains a phosphorus element on the surface or on the surface and inside of the secondary particle. The element X is one or more elements selected from the group consisting of Co, Mn, Fe, Cu, Ti, Mg, Ca, Al, W, Mo, Nb, Zn, Sn, Zr, Ga, V, B, and Si. CAM satisfies requirements (1), (2), and (3) below.
requirement (1): a value of XPS(P)/XPS(Li) is more than 0 and 0.15 or less
(Here, XPS(P) represents an abundance ratio [at %] of the phosphorus element obtained from a P2p spectrum measured by X-ray photoelectron spectroscopy, and XPS(Li) represents an abundance ratio [at %] of Li obtained from a Li1s spectrum measured by X-ray photoelectron spectroscopy.)
requirement (2): a peak attributed to lithium phosphate is present at 2θ=21 to 250 in a powder X-ray diffraction pattern obtained by powder X-ray diffraction measurement.
requirement (3): an amount of lithium eluted obtained by a neutralization titration method is less than 0.20 wt %.

As described below, in the production of CAM, lithium compound such as lithium hydroxide may be used as a raw material. In addition, lithium carbonate may be contained as an impurity in the raw material or as a by-product from lithium hydroxide.

For example, when lithium hydroxide or lithium carbonate comes into contact with an electrolytic solution, the electrolytic solution may decompose and generate gases. The gases generated may cause a deterioration of the cycle characteristic and discharge rate characteristic.

In addition, a slurry obtained by mixing CAM with a binder or the like is applied to a current collector, so that a positive electrode can be obtained. Here, the reaction of lithium hydroxide with the binder may cause a gelation of the slurry, and when a gelation occurs, it becomes difficult to obtain a positive electrode in which CAM is uniformly coated, which may result in a deterioration of the cycle characteristic and discharge rate characteristic.

Conventionally, in order to remove the remaining lithium compound, washing using water has been performed in some case. However, when the washing is performed, there may be problems of increase in production cost and deterioration of battery performance due to over-washing.

In an embodiment of the present invention, X-ray photoelectron spectroscopy (XPS) in the requirement (1) is a measurement method of analyzing constituent elements on the surface of particles contained in CAM by measuring the energy of photoelectrons generated when the surface of particles contained in CAM is irradiated with X-rays. The abundance ratio of each element in the surface region of particles in CAM according to an embodiment of the present invention can be measured by the above XPS. The above XPS is a method of analyzing the binding energy of photoelectrons emitted from the surface of particles in CAM when irradiated, for example, with AlKα rays as X-ray excitation sources. Specifically, PHI5000 VersaProbe III manufactured by ULVAC-PHI, INC., can be used as the X-ray photoelectron spectrometer.

Here, the surface region of particles contained in CAM refers to a region where constituent elements and electronic states can be analyzed by XPS measurement. Specifically, it is a depth region where generated photoelectrons can escape in the direction from the outermost surface of particles in CAM toward the center. This depth region refers to a region having a depth up to about 10 nm.

The measurement conditions for XPS may be appropriately adjusted so that most of the particles contained in CAM can be measured. Examples of the conditions include an X-ray irradiation diameter of 100 μm, PassEnergy of 112 eV, Step of 0.1 eV, and Dwelltime of 50 ms. For each XPS spectrum to be obtained, the peak area of the spectrum of each element is calculated using an analysis software (MultiPak (Version 9.9.0.8)). Based on the peak area of the spectrum of each element calculated, the ratio of the number of each element to the total value of 100 at % of the number of each element, that is, the abundance ratio of each element can be calculated. In the present embodiment, the charge of the peak attributed to surface-contaminated hydrocarbons in the C1s spectrum is corrected to 284.6 eV.

In an embodiment of the present invention, XPS(P) represents the abundance ratio [at %] of the phosphorus element calculated based on the peak area of the P2p spectrum measured by XPS. Specifically, the P2p spectrum has a peak with a binding energy in the range of 130 to 138 eV. More specifically, XPS(P) represents the total value of the abundance ratio of the phosphorus element derived from a phosphorus compound such as lithium phosphate in the surface region of CAM particles present in the range irradiated with X-rays. XPS(P) is preferably 0.01 at % or more, more preferably 0.10 at % or more. In addition, XPS(P) is preferably 4.5 at % or less, more preferably 4.3 at % or less. The upper limit value and lower limit value of XPS(P) can be arbitrarily combined. Examples of such combinations include 0.01 to 4.5 at % and 0.10 to 4.3 at %.

In an embodiment of the present invention, XPS(Li) represents the abundance ratio [at %] of Li calculated based on the peak area of the Li1s spectrum measured by XPS. Specifically, the Li1s spectrum has a peak with a binding energy in the range of 53 to 57 eV. More specifically, the peak with a binding energy in the range of 53 to 57 eV represents Li derived from the aforementioned remaining lithium compound such as lithium hydroxide and lithium carbonate, and LiMO. XPS(Li) represents the total value of the abundance ratio of Li derived from the above lithium compound and LiMO in the surface region of CAM particles present in the range irradiated with X-rays. XPS(Li) is preferably 20 at % or more, more preferably 21 at % or more. In addition, XPS(Li) is preferably 30 at % or less, more preferably 29 at % or less. The upper limit value and lower limit value of XPS(Li) can be arbitrarily combined. Examples of such combinations include 20 to 30 at % and 21 to 29 at %.

CAM according to an embodiment of the present invention satisfies the requirement (1). Here, the value of XPS(P)/XPS(Li) is the ratio between the abundance ratio of the phosphorus element and the abundance ratio of Li in the surface region of CAM particles present in the range irradiated with X-rays described above.

The value of XPS(P)/XPS(Li) of more than 0 means that the surface of secondary particles in LiMO contained in CAM contains the phosphorus element, and at least a part of the lithium compound remaining on the surface of particles in CAM reacts with the phosphate to be converted into the lithium phosphate, as a result of which the amount of the lithium compound remaining on the surface of particles in CAM is reduced, in CAM according to an embodiment of the present invention. As mentioned above, the remaining lithium compound can cause a deterioration in battery characteristics of a lithium secondary battery. Therefore, CAM according to an embodiment of the present invention can suppress the deterioration in battery characteristics described above by having the value of XPS(P)/XPS(Li) of more than 0. For suppressing the deterioration in battery characteristics described above, the value of XPS(P)/XPS(Li) is preferably 0.005 or more, more preferably 0.01 or more.

The value of XPS(P)/XPS(Li) of 0.15 or less means that the abundance ratio of the phosphorus element derived from the lithium phosphate is as small as it cannot cover the entire particle surface on the surface of particles in CAM. In other words, the particles in CAM according to an embodiment of the present invention have a structure to allow the lithium phosphate to adhere to a part of its surface. In CAM according to an embodiment of the present invention, the lithium phosphate appropriately adheres to particle surface by the value of XPS(P)/XPS(Li) being 0.15 or less, so that the cycle characteristic and discharge rate characteristic of the lithium secondary battery can be improved. For improving the cycle characteristic and discharge rate characteristic of the lithium secondary battery, the value of XPS(P)/XPS(Li) is preferably less than 0.1, more preferably 0.08 or less.

The upper limit value and lower limit value of XPS(P)/XPS(Li) can be arbitrarily combined. Examples of such combinations include 0.005 or more and less than 0.1 and 0.01 to 0.08.

Accordingly, CAM according to an embodiment of the present invention can improve the cycle characteristic and discharge rate characteristic of the lithium secondary battery by satisfying the requirement (1).

The upper limit value and lower limit value of XPS(P)/XPS(Li) can be arbitrarily combined. The value of XPS(P)/XPS(Li) is preferably more than 0 and less than 0.1, more preferably 0.005 or more and less than 0.1, still more preferably 0.01 to 0.08.

The lithium phosphate can exist inside CAM. It is inferred that this also can improve the cycle characteristic and discharge rate characteristic of the lithium secondary battery.

CAM according to an embodiment of the present invention satisfies the requirement (2). Here, “a peak attributed to lithium phosphate is present at 2θ=21 to 250” indicates that the ratio of the height H(γ) of the lowest peak among the peaks attributed to the lithium phosphate to the height of the peak present at 2θ=18.5±1° is 0.0045 or more. Among the peaks attributed to the lithium phosphate, the lowest peak is preferably present at 2θ=24.7±1°. The height of the peak present at 2θ=18.5±1° corresponds to H(β) described below. In the powder X-ray diffraction pattern, a peak attributed to lithium phosphate being present at 2θ=21 to 25° means that the phosphorus element is contained on the surface or on the surface and inside of the secondary particles in LiMO contained in CAM, and the phosphorus element exists as lithium phosphate (Li₃PO₄) with high crystallinity in CAM according to an embodiment of the present invention. Here, the conductivity of CAM itself is improved by containing the lithium phosphate with high crystallinity, as a result of which the battery characteristics such as the cycle characteristic and discharge rate characteristic are improved. Accordingly, CAM according to an embodiment of the present invention can improve the cycle characteristic and discharge rate characteristic of the lithium secondary battery by satisfying the requirement (2).

CAM according to an embodiment of the present invention satisfies the requirement (3). By the amount of lithium eluted of less than 0.20 wt %, gases resulting from decomposition of the electrolytic solution due to the reaction of the lithium compound contained in CAM with the electrolytic solution are unlikely to be generated, and therefore the battery cycle characteristic is unlikely to deteriorate. Accordingly, CAM according to an embodiment of the present invention can improve both of the cycle characteristic and discharge rate characteristic of the lithium secondary battery by satisfying the requirement (3).

The amount of lithium eluted obtained from neutralization titration method is preferably 0.01 to 0.19 wt %, more preferably 0.01 to 0.18 wt %. In this description, the amount of lithium eluted is a concentration of alkaline lithium compounds eluted from CAM. The amount of lithium eluted serves as an index of the amount of lithium compound remaining in CAM. The amount of lithium eluted can be measured by the method described in Examples.

In an embodiment of the present invention, the peaks attributed to the lithium phosphate can include the peak present at 2θ=22.5±1°. The height H(α) of the peak present at 2θ=22.5±1° among the peaks attributed to the lithium phosphate and the height H(β) of the peak present at 2θ=18.5±1° preferably satisfy the relationship of 0.003≤H(α)/H(β) 0.03. H(α) is a parameter dependent on the content of lithium phosphate with high crystallinity. In addition, H(β) is a peak attributed to the (003) plane of LiMO and is a parameter dependent on the content of LiMO. Therefore, the value of H(α)/H(β) represents a ratio of the contents of lithium phosphate with high crystallinity to LiMO. The lower limit of the value of H(α)/H(β) is more preferably 0.005 or more, particularly preferably 0.010 or more. In addition, the upper limit of the value of H(α)/H(β) is more preferably 0.025 or less, particularly preferably 0.020 or less. The upper limit value and lower limit value of H(α)/H(β) can be arbitrarily combined. For example, the combination is more preferably 0.005≤H(α)/H(β)≤0.025, particularly preferably 0.010≤H(α)/H(β)≤0.020.

In an embodiment of the present invention, the molar ratio of Li, Ni, the element X, and the phosphorus element preferably satisfies a formula (1) below, in view of the cycle characteristic of the battery.

$$Li : Ni : X : P = a : ( 1 - b ) : b : c \qquad ( 1 )$$

(In the formula (1), a, b, and c satisfy 0.90≤a≤1.2, 0≤b≤0.7, and 0.003≤c≤0.03.)

The lower limit of a in the formula (1) is more preferably 0.95 or more, still more preferably 0.98 or more. In addition, the upper limit of a in the formula (1) is more preferably 1.10 or less, still more preferably 1.08 or less. The upper limit value and lower limit value of a can be arbitrarily combined. Examples of such combinations include 0.95 to 1.10 and 0.98 to 1.08.

The lower limit of b in the formula (1) is more preferably 0.01 or more, still more preferably 0.02 or more. In addition, the upper limit of b in the formula (1) is more preferably 0.3 or less, still more preferably 0.2 or less. The upper limit value and lower limit value of b in the formula (1) can be arbitrarily combined. Examples of such combinations include 0 to 0.3, 0.01 to 0.3, and 0.02 to 0.3. It is preferable that b in the formula (1) is 0 to 0.3.

The lower limit of c in the formula (1) is more preferably 0.005 or more, still more preferably 0.01 or more. In addition, the upper limit of c in the formula (1) is more preferably 0.025 or less, still more preferably 0.022 or less. The upper limit value and lower limit value of c in the formula (1) can be arbitrarily combined. Examples of such combinations include 0.005 to 0.025 and 0.01 to 0.022.

CAM according to an embodiment of the present invention contains a particle of a lithium metal composite oxide (LiMO), and preferably contains LiMO and lithium phosphate. LiMO contains at least Li, Ni, and the element X described above. The particle of LiMO contains a secondary particle which is an aggregate of primary particles. The secondary particle of LiMO at least contains the phosphorus element on the surface thereof. LiMO may contain the phosphorus element in addition to Li, Ni, and the element X. In other words, the secondary particle of LiMO contains the phosphorus element on the surface or on the surface and inside thereof. In addition, LiMO may contain the sulfur element in addition to Li, Ni, and the element X.

The element X to be contained in CAM according to an embodiment of the present invention is preferably one or more elements selected from the group consisting of Co, Mn, Ti, Mg, Ca, Al, W, Mo, Nb, Zr, B, and Si, more preferably one or more elements selected from the group consisting of Co, Mn, Ti, Mg, Ca, Al, W, Mo, Nb, and Zr, in view of the initial capacity of the battery.

Furthermore, LiMO is preferably represented by a formula (I) below.

$$Li [ {{Li}_{m} ( {Ni}_{( 1 - n )} {X}_{n} )}_{1 - m} ] {O}_{2} \qquad ( I )$$

In the formula (I), X represents the element X described above. In the formula (I), −0.1≤m≤0.2 and 0≤n≤0.7 are preferably satisfied.

In the formula (I), m is preferably −0.1 or more, more preferably −0.05 or more, still more preferably −0.03 or more, particularly preferably 0 or more, in view of the initial capacity of the battery. In addition, m is preferably 0.20 or less, more preferably 0.10 or less, still more preferably 0.05 or less, particularly preferably 0.03 or less, for preventing the deterioration in cycle characteristic of the battery by reducing the amount of remaining lithium compound. The upper limit value and lower limit value of m can be arbitrarily combined. For example, the combination is preferably −0.05≤m≤0.05, more preferably −0.03≤m≤0.03.

In the formula (I), n may be 0 but is preferably 0.01 or more, more preferably 0.03 or more, still more preferably 0.05 or more, in view of the cycle characteristic of the battery. In addition, n is preferably 0.70 or less, more preferably 0.30 or less, still more preferably 0.15 or less, in view of the battery capacity. The upper limit value and lower limit value of n can be arbitrarily combined. For example, the combination is preferably 0.01≤n≤0.30, more preferably 0.03≤n≤0.15.

In the case where the content of Ni in LiMO is high, the cycle characteristic tend to be poor, as compared with the case where the content of Ni is low. In CAM according to the present embodiment, even in the case of containing LiMO with a high Ni content, it is possible to prevent the deterioration in cycle characteristic of the battery.

The composition of LiMO can be analyzed using an ICP emission spectrometer after dissolving LiMO with an acid. The composition of CAM can be analyzed using an ICP emission spectrometer after a dissolution treatment of dissolving CAM powder by mixing with an acid or alkali or in microwaves. As the ICP emission spectrometer, for example, SPS3000 manufactured by Seiko Instruments Inc. can be used.

CAM according to an embodiment of the present invention may contain a sulfate anion (SO₄²⁻). In an embodiment of the present invention, the value of XPS(P)/XPS(S) of CAM is preferably more than 0 and 2.0 or less, more preferably more than 0 and 1.50 or less, still more preferably 0.50 to 1.50, for further improving the cycle characteristic and discharge rate characteristic of the lithium secondary battery. The sulfate anion can be contained, for example, in the raw material of CAM as an impurity.

In an embodiment of the present invention, XPS(S) represents the abundance ratio [at %] of the sulfur element obtained from the S2p spectrum measured by X-ray photoelectron spectroscopy. XPS(S) represents the total value of the abundance ratio of the sulfur element in the surface region of CAM particles present in the range irradiated with X-rays. The S2p spectrum has a peak in the range of 165 to 175 eV. XPS(S) is preferably more than 0 at %, more preferably 0.1 at % or more. In addition, XPS(S) is preferably 1.5 at % or less, more preferably 1.0 at % or less. The upper limit value and lower limit value of XPS(S) can be arbitrarily combined. Examples of such combinations include more than 0 at % and 1.5 at % or less and 0.1 to 1.0 at %.

The crystal structure of CAM according to an embodiment of the present invention is a layered structure. The crystal structure is preferably a hexagonal crystal structure or a monoclinic crystal structure.

The hexagonal crystal structure is attributed to any one space group selected from the group consisting of P3, P31, P32, R3, P-3, R-3, P312, P321, P3112, P3121, P3212, P3221, R32, P3 ml, P31m, P3c1, P31c, R3m, R3c, P-31m, P-31c, P-3 ml, P-3cd, R-3m, R-3c, P6, P61, P65, P62, P64, P63, P-6, P6/m, P63/m, P622, P6122, P6522, P6222, P6422, P6322, P6 mm, P6cc, P63 cm, P63mc, P-6m2, P-6c2, P-62m, P-62c, P6/mmm, P6/mcc, P63/mcm, and P63/mmc.

In addition, the monoclinic crystal structure is attributed to any one space group selected from the group consisting of P2, P21, C2, Pm, Pc, Cm, Cc, P2/m, P21/m, C2/m, P2/c, P21/c, and C2/c.

Among these, the crystal structure of CAM is particularly preferably a hexagonal crystal structure attributed to the space group R-3m or a monoclinic crystal structure attributed to the space group C2/m, for achieving a lithium secondary battery with high initial discharge capacity.

The crystal structure of CAM can be measured using an X-ray diffractometer (for example, UltimaIV manufactured by Rigaku Corporation).

The 50% cumulative volume particle diameter D₅₀ of CAM according to an embodiment of the present invention (which will be hereinafter referred to also as simply “D₅₀”) is preferably 5 to 20 μm, more preferably 5.0 to 15.0 μm, still more preferably 8.0 to 15.0 μm, particularly preferably 9.0 to 15.0 μm, in view of the cycle characteristic of the battery. The D₅₀ of CAM means the value of the particle diameter at the point where the cumulative volume from the fine particle side is 50% when the whole is 100% in the volume-based cumulative particle size distribution curve obtained for CAM. The D₅₀ of CAM can be measured by the method described in Examples.

For example, CAM according to an embodiment of the present invention can be produced by the method for producing CAM according to an embodiment of the present invention, which will be described below.

### [2. Method for Producing Positive Electrode Active Material for Lithium Secondary Battery]

The method for producing CAM according to an embodiment of the present invention includes: a first mixing step of mixing a metal composite compound containing Ni and the element X with a lithium compound to obtain a first mixture; a first calcining step of calcining the first mixture in an oxygen-containing atmosphere to obtain LiMO; a second mixing step of mixing LiMO and a phosphate so that the molar ratio of Ni and the element X contained in LiMO and the phosphorus element contained in the phosphate satisfies a formula (2) below to obtain a second mixture,

Ni:X:P=(1−b):b:c

(in the formula (2), b and c satisfy 0≤b≤0.7 and 0.003≤c≤0.03); and a second calcining step of calcining the second mixture in an oxygen-containing atmosphere, the element X is one or more elements selected from the group consisting of Co, Mn, Fe, Cu, Ti, Mg, Ca, Al, W, Mo, Nb, Zn, Sn, Zr, Ga, V, B, and Si, the highest holding temperature T₁ in the first calcining step is 500 to 750° C., and the highest holding temperature T₂ in the second calcining step is 650 to 900° C.

### <First Mixing Step>

The first mixing step is a step of mixing a metal composite compound containing Ni and the element X with a lithium compound to obtain a first mixture.

In the first mixing step, examples of the lithium compound include lithium hydroxide, lithium hydroxide monohydrate, lithium carbonate, lithium nitrate, lithium acetate, lithium oxide, lithium chloride, lithium fluoride, and the like. One of these may be used alone, or two or more of them may be used. Lithium hydroxide, lithium acetate, and the like can react with carbon dioxide in the air to produce lithium carbonate. For example, it is preferable to use lithium hydroxide or lithium hydroxide monohydrate as a lithium compound. 5 mass % or less of lithium carbonate may be contained as an impurity in lithium hydroxide or lithium hydroxide monohydrate described above.

In the first mixing step, the metal composite compound may be referred to also as MCC or precursor material. MCC contains Ni and at least one element X selected from the group consisting of Co, Mn, Fe, Cu, Ti, Mg, Al, W, Mo, Nb, Zn, Sn, Zr, Ga, V, B, and Si. MCC is preferably a metal composite hydroxide or a metal composite oxide.

In the first mixing step, the mixing ratio of the lithium compound and MCC can be adjusted in consideration of the composition ratio of the final target compound. Specifically, the amount (molar ratio) Li of contained in the lithium compound to the total amount 1 of metal elements contained in MCC is preferably 0.99 or more, more preferably 1.00 or more, still more preferably 1.02 or more.

In the first mixing step, the method for mixing the lithium compound and MCC is not specifically limited.

MCC can be produced by coprecipitation methods such as the batch coprecipitation method or the continuous coprecipitation method. Hereinafter, the production method thereof will be described in detail by way of example of a metal composite hydroxide containing Ni, Co, and Al.

First, a nickel salt solution, a cobalt salt solution, an aluminum salt solution, and a complexing agent are reacted in a reaction vessel by a coprecipitation method, especially, the continuous method disclosed in JP2002-201028A, to produce a metal composite hydroxide represented by Ni_{(1-b-c)}Co_{b}Al_{c}(OH)₂ (in a formula, b+c<1.) It is preferable to use a continuous reaction vessel for the coprecipitation method. CAM having D₅₀ within a desired range is easily obtained by the continuous coprecipitation method.

Examples of the nickel salt that is a solute of the nickel salt solution include nickel sulfate, nickel nitrate, nickel chloride, nickel acetate, and the like. Examples of the cobalt salt that is a solute of the cobalt salt solution include cobalt sulfate, cobalt nitrate, cobalt chloride, cobalt acetate, and the like. Examples of the aluminum salt that is a solute of the aluminum salt solution include aluminum sulfate, sodium aluminate, and the like. The aforementioned metal salts are used at a ratio corresponding to the composition ratio of Ni_{(1-b-c)}Co_{b}Al_{c}(OH)₂. In addition, these metal salts may be used individually or in combination of two or more types. As the solvent, water can be used.

The complexing agent is a compound that can form a complex with Ni, Co, and Al ions in an aqueous solution. Examples of the complexing agent include ammonium ion donors (ammonium salts such as ammonium hydroxide, ammonium sulfate, ammonium chloride, ammonium carbonate, and ammonium fluoride), hydrazine, ethylenediaminetetraacetic acid, nitrilotriacetic acid, uracil diacetic acid, and glycine.

The complexing agent may or may not be used in the coprecipitation method. In the case of using the complexing agent, the amount of the complexing agent contained in a liquid mixture containing a nickel salt solution, a cobalt salt solution, a manganese salt solution, and a complexing agent is, for example, such that the molar ratio to the total number of moles of metal salts is more than 0 and 2.0 or less.

In the coprecipitation method, the pH value of the liquid mixture containing a nickel salt solution, a cobalt salt solution, a manganese salt solution, and a complexing agent is adjusted, if necessary. For example, before the liquid mixture changes from alkaline to neutral, an alkaline aqueous solution is added to the liquid mixture. Examples of the alkaline aqueous solution include a sodium hydroxide aqueous solution, a potassium hydroxide aqueous solution, and the like.

The pH of the liquid mixture is measured when the temperature of the liquid mixture sampled from the reaction vessel reaches 40° C. When the temperature of the liquid mixture sampled is lower or higher than 40° C., the liquid mixture is appropriately heated or cooled to adjust it to 40° C., and then the pH is measured.

During the reaction, the temperature of the reaction vessel is controlled within the range of, for example, 20 to 80° C., preferably 30 to 70° C. In addition, the pH value in the reaction vessel is controlled within the range of, for example, pH 9 to 13, preferably pH 11 to 13.

The material in the reaction vessel is appropriately stirred and mixed. As the reaction vessel, an overflow type reaction vessel can be used to separate a reaction precipitate formed.

The inside of the reaction vessel may be an inert atmosphere. In an inert atmosphere, elements that are more easily oxidized than Ni can be prevented from aggregating, and a uniform metal composite hydroxide can be obtained.

In addition, while an inert atmosphere is maintained, the inside of the reaction vessel may be in an appropriate oxygen-containing atmosphere, or in the presence of an oxidizing agent. An inert atmosphere can be maintained unless a large amount of oxygen gas is introduced into the reaction vessel. In addition, when controlling the atmosphere in the reaction vessel by a gas species, a predetermined gas species may be passed through the reaction vessel, or the reaction solution may be directly bubbled.

In addition to controlling the conditions described above, the oxidation state of the reaction product to be obtained may be controlled by supplying various gases (e.g., inert gases such as nitrogen, argon, and carbon dioxide; oxidizing gases such as air and oxygen; or mixed gases thereof) into the reaction vessel. In addition, peroxides such as hydrogen peroxide; peroxides salts such as permanganates; perchlorates; hypochlorites; nitric acid; halogens; ozone, and the like may be used as compounds that oxidize reaction products. Alternatively, organic acids such as oxalic acid and formic acid; sulfites; and hydrazine may be used as compounds that reduce reaction products to be obtained.

After the above reactions, the reaction products obtained are washed with water and then dried to obtain a metal composite hydroxide. In addition, when impurities derived from the liquid mixture remain in the reaction product only by washing with water, the reaction product may be washed with weak acid water, or an alkaline solution containing sodium hydroxide or potassium hydroxide, as required.

A metal composite oxide may be further prepared from the metal composite hydroxide obtained. For example, a nickel cobalt aluminum metal composite oxide can be prepared by heating a nickel cobalt aluminum metal composite hydroxide.

The heating time as the total time from the start of the temperature rise to the end of the temperature holding after the desired temperature is reached is completed is preferably set to 1 to 30 hours. The heating temperature can be, for example, 300 to 800° C.

In an embodiment of the present invention, MCC may contain 500 to 10000 ppm, preferably 1500 to 7500 ppm of sulfate anion relative to the total weight of MCC.

The content of sulfate anion in MCC can be obtained by using an ICP emission spectrometer (for example, SPS3000 manufactured by Seiko Instruments Inc.), after dissolving MCC powder in hydrochloric acid, and converting the value of the content of the sulfur element to be obtained into sulfate anion (SO₄⁻).

Before mixing with the lithium compound, MCC may be dried. The drying conditions for MCC are not specifically limited, and may be, for example, any of conditions 1) to 3) below.
1) Conditions in which the metal composite oxide or metal composite hydroxide is not oxidized or reduced. Specifically, drying conditions in which the metal composite oxide is maintained as a metal composite oxide, or drying conditions in which the metal composite hydroxide is maintained as a metal composite hydroxide.
2) Drying conditions in which the metal composite hydroxide is oxidized to a metal composite oxide.
3) Drying conditions in which the metal composite oxide is reduced to a metal composite hydroxide.

In order to achieve the conditions 1), an inert gas such as nitrogen, helium, or argon can be used as the atmosphere during drying. In order to achieve the conditions 2), oxygen or air can be used as the atmosphere during drying. In order to achieve the conditions 3), a reductant such as hydrazine or sodium sulfite can be used in an inert gas atmosphere during drying. After drying MCC, classification may be performed as appropriate.

### <First Calcining Step>

The first calcining step is a step of calcining the first mixture in an oxygen-containing atmosphere to obtain LiMO. That is, the first mixture containing MCC and the lithium compound is calcined to obtain LiMO in the first calcining step. For example, a lithium-nickel cobalt aluminum metal composite oxide is obtained by calcining a mixture of a nickel cobalt aluminum metal composite hydroxide and the lithium compound.

The highest holding temperature (calcining temperature) T₁ in the first calcining step is 500 to 750° C. T₁ of 500° C. or more can appropriately accelerate the growth of LiMO particle to be obtained. For appropriately accelerating the growth of LiMO particle, T₁ is preferably 550° C. or more, more preferably 600° C. or more. Meanwhile, T₁ of 750° C. or less can reduce the volatilization of lithium ions on the surface of LiMO particle to be obtained. For appropriately maintaining the amount of Li contained in LiMO particle, T₁ is preferably 740° C. or less, more preferably 730° C. or less. The upper limit value and lower limit value of T₁ can be arbitrarily combined. Examples of such combinations include 550 to 740° C. and 600 to 730° C. In this description, the highest holding temperature in the calcining step means the highest holding temperature of the atmosphere in the calcination furnace.

The first calcining step may be performed only once or in multiple times. In the case of performing it in multiple times, the temperature in a calcining step with the highest temperature is taken as T₁ described above.

### <Second Mixing Step>

The second mixing step is a step of mixing LiMO obtained in the first calcining step and a phosphate so that the molar ratio of Ni and the element X contained in LiMO, and the phosphorus element contained in the phosphate satisfies a formula (2) below to obtain a second mixture.

$$Ni : X : P = ( 1 - b ) : b : c \qquad ( 2 )$$

(In the formula (2), b and c satisfy 0≤b≤0.7 and 0.003≤c≤0.03.)

The lower limit of b in the formula (2) is more preferably 0.01 or more, still more preferably 0.02 or more. In addition, the upper limit of b in the formula (2) is more preferably 0.3 or less, still more preferably 0.2 or less. The upper limit value and lower limit value of b in the formula (2) can be arbitrarily combined. Examples of such combinations include 0 to 0.3, 0.01 to 0.3, and 0.02 to 0.3. It is preferable that b in the formula (2) is 0 to 0.3.

The lower limit of c in the formula (2) is more preferably 0.005 or more, still more preferably 0.01 or more. In addition, the upper limit of c in the formula (2) is more preferably 0.025 or less, still more preferably 0.022 or less. The upper limit value and lower limit value of c in the formula (2) can be arbitrarily combined. Examples of such combinations include 0.005 to 0.025 and 0.01 to 0.022.

In the second mixing step, the method for mixing LiMO obtained in the first calcining step and the phosphate is not specifically limited, and any of dry mixing or wet mixing can be employed. Here, it is preferable to employ wet mixing since LiMO obtained in the first calcining step and the phosphate can be mixed more uniformly, and the cycle characteristic and discharge rate characteristic of the battery can be improved.

In addition, in the case of employing wet mixing in the second mixing step, the second mixture preferably contains 1 to 15 wt %, more preferably 2 to 10 wt % of water relative to the total weight of the second mixture. Thereby, LiMO obtained in the first calcining step and the phosphate can be mixed further uniformly, and the cycle characteristic and discharge rate characteristic of the battery can be improved. The water content of the second mixture can be adjusted by adjusting the amount of water to be added in the second mixing step.

Examples of the wet mixing can include an aspect of mixing LiMO obtained in the first calcining step and the phosphate powder, then adding water, and further mixing, and an aspect of spraying water in which the phosphate has been dissolved to LiMO obtained in the first calcining step, mixing, and the like.

A BET specific surface area of the phosphate powder is preferably 0.1 to 10 m²/g, more preferably 0.15 to 5 m²/g, since it is possible to uniformly react with unreacted lithium compound remaining in LiMO, so that the cycle characteristic and discharge rate characteristic of the battery can be improved. The BET specific surface area of the phosphate powder can be measured using a BET specific surface area meter. As the BET specific surface area meter, Macsorb (registered trademark) manufactured by Mountech Co., Ltd., for example, can be used.

The phosphate is not limited. Examples of the anionic species constituting the phosphate can include any one selected from the group consisting of PO₄³⁻, HPO₄²⁻, and H₂PO₄⁻. In addition, example of the cationic species constituting the phosphate can include one or more selected from the group consisting of Al, Mg, Ca, NH₄, Co, Mn, Ti, and Zr. Additionally, the phosphate may be a hydrate.

Specific examples of the phosphate can include AlPO₄, MgHPO₄, MgHPO₄·3H₂O, Mg(H₂PO₄)₂, Mg(H₂PO₄)₂·4H₂O, MgNH₄PO₄, MgNH₄PO₄·6H₂O, NH₄H₂PO₄, (NH₄)₂HPO₄, CaHPO₄, CaHPO₄·2H₂O, Zr(HPO₄)₂, Zr(HPO₄)₂·2H₂O, Ti(HPO₄)₂, Ti(HPO₄)₂·2H₂O, Co₃(PO₄)₂, Co₃(PO₄)₂·8H₂O, Mn(H₂PO₄)₂·4H₂O, and the like.

In the second mixing step, CAM which satisfies the requirements (1) to (3) can be obtained by mixing LiMO and the phosphate so that the formula (2) is satisfied. Furthermore, use of CAM which satisfies the requirements (1) to (3) can improve the cycle characteristic and discharge rate characteristic of the battery. XPS(P)/XPS(Li), H(α)/H(β), XPS(P)/XPS(S), and the amount of lithium eluted of CAM can be controlled by adjusting b and c in the formula (2).

### <Second Calcining Step>

The second calcining step is a step of calcining the second mixture in an oxygen-containing atmosphere.

The highest holding temperature (calcining temperature) T₂ in the second calcining step is 650 to 900° C. T₂ of 650° C. or more enables the phosphate to be diffused into the crystal structure of LiMO to be obtained. In addition, CAM in which the lithium phosphate is moderately attached to the surface of LiMO particle can be produced. Furthermore, T₂ of 650° C. or more allows lithium phosphate contained in CAM to be obtained to form lithium phosphate with high crystallinity. Accordingly, T₂ of 650° C. or more enables CAM which satisfies the requirements (1) to (3) to be appropriately produced. Furthermore, the cycle characteristic and discharge rate characteristic of the battery can be improved by using CAM which satisfies the requirements (1) to (3). For appropriately produce CAM according to an embodiment of the present invention, T₂ is preferably 680° C. or more, more preferably 700° C. or more. Meanwhile, T₂ of 900° C. or less can prevent the formation of cracks in LiMO particle to be obtained and appropriately maintain the particle intensity. For appropriately maintaining the particle intensity of LiMO particle, T₂ is preferably 880° C. or less, more preferably 850° C. or less. The upper limit value and lower limit value of T₂ can be arbitrarily combined. Examples of such combinations include 680 to 880° C. and 700 to 850° C.

XPS(P)/XPS(Li), H((t)/H(β), XPS(P)/XPS(S), and the amount of lithium eluted in CAM to be produced can be controlled by adjusting T₂.

As mentioned above, CAM according to an embodiment of the present invention can improve the cycle characteristic and discharge rate characteristic of the lithium secondary battery by satisfying the requirements (1) to (3). Accordingly, the method for producing CAM according to an embodiment of the present invention can produce CAM that can improve the cycle characteristic and discharge rate characteristic of the lithium secondary battery.

T₁ and T₂ preferably satisfy the condition of T₂≥T₁, more preferably satisfy a condition that the value of T₂−T₁ is 10 to 250° C., still more preferably satisfy a condition that the value of T₂−T₁ is 20 to 250° C., and particularly preferably satisfy a condition that the value of T₂−T₁ satisfy the condition of 20 to 150° C. The relationship of T₁ and T₂ satisfying the aforementioned conditions allows CAM which satisfies the requirements (1) to (3) and can improve the cycle characteristic and discharge rate characteristic of the lithium secondary battery to be produced more appropriately.

### <Other Steps>

The method for producing CAM according to an embodiment of the present invention may include a crushing step of crushing the calcined product obtained by calcining after the first calcining step and/or the second calcining step. For the crushing step, a disk mill, a pin mill, and a jet mill can be used.

### [3. Lithium Secondary Battery]

Next, a suitable configuration of a lithium secondary battery in a case where CAM to be obtained by the production method of the present embodiment is used will be described. In addition, a suitable positive electrode for a lithium secondary battery in a case where CAM to be obtained by the production method of the present embodiment is used will be described. Furthermore, a lithium secondary battery will be described as a suitable application of the positive electrode.

An example of the lithium secondary battery of the present embodiment has a positive electrode, a negative electrode, a separator interposed between the positive electrode and the negative electrode, and an electrolytic solution disposed between the positive electrode and the negative electrode. The positive electrode, the negative electrode, the separator may be collectively referred to also as an electrode group.

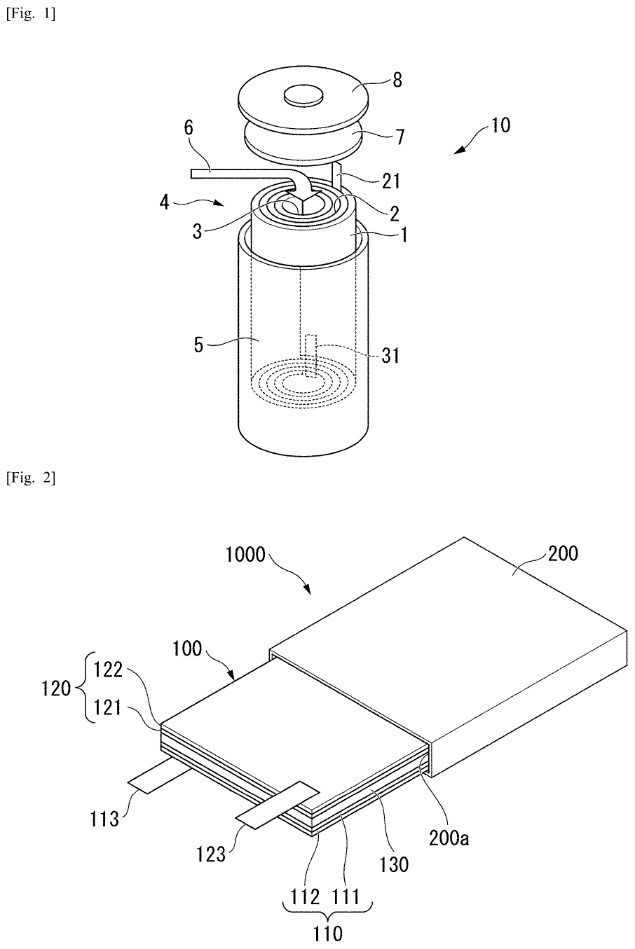

FIG. 1 is a schematic view showing an example of an electrode group of the lithium secondary battery. A cylindrical lithium secondary battery 10 of the present embodiment can be produced, as follows.

First, as shown in FIG. 1, a pair of separators 1, a positive electrode 2, and a negative electrode 3 are laminated in the order of the separator 1, the positive electrode 2, the separator 1, and the negative electrode 3, and are wound up to form an electrode group 4. The separators 1, the positive electrode 2 and the negative electrode 3 are each strip-shaped. The positive electrode 2 has a positive electrode lead 21 at one end. The negative electrode 3 has a negative electrode lead 31 at one end.

Next, the electrode group 4 and an insulator which is not shown are accommodated in a battery can 5. Thereafter, the bottom of the battery can 5 is sealed. Then, the electrolyte is disposed between the positive electrode 2 and the negative electrode 3 by impregnating the electrode group 4 with an electrolytic solution 6. Furthermore, the upper part of the battery can 5 is sealed with a top insulator 7 and a sealing body 8, so that the lithium secondary battery 10 can be produced.

Examples of the shape of the electrode group 4 include a columnar shape. For example, the cross-sectional shape of the electrode group 4 when is cut in a direction perpendicular to the winding axis may be a circle, an ellipse, a rectangle, or a rectangle with rounded corners.

In addition, as a shape of the lithium secondary battery having such an electrode group 4, a shape defined by IEC60086, which is a standard for batteries established by the International Electrotechnical Commission (IEC) or JIS C 8500 can be adopted. As a shape, for example, shapes such as a cylindrical type and a square type can be exemplary examples.

Furthermore, the lithium secondary battery is not limited to the winding-type configuration and may have a laminated-type configuration in which the laminated structure of the positive electrode, the separator, the negative electrode, and the separator is repeatedly overlaid. As the laminated-type lithium secondary battery, a so-called coin-type battery, button-type battery, or paper-type (or sheet-type) battery can be an exemplary example.

Hereinafter, each configuration will be sequentially described.

### <3-1. Positive Electrode>

The positive electrode can be produced by first preparing a positive electrode mixture containing CAM, a conductive material, and a binder, and supporting the positive electrode mixture on a positive electrode current collector.

### <3-2. Negative Electrode>

The negative electrode of the lithium secondary battery can be doped and dedoped with lithium ions at a lower potential than the positive electrode. As the negative electrode, an electrode in which a negative electrode mixture containing a negative electrode active material is supported on a negative electrode current collector and an electrode consisting of a negative electrode active material alone are exemplary examples.

For the positive electrode, the separator, the negative electrode, and the electrolytic solution that configure the lithium secondary battery, the configurations, materials, and the production method disclosed in [0113] to [0140] of WO2022/113904A1 can be used, for example.

### [4. All-Solid-State Lithium Secondary Battery]

Next, a positive electrode using CAM according to an embodiment of the present invention as CAM of an all-solid-state lithium secondary battery, and the all-solid-state lithium secondary battery having the positive electrode will be described while describing the configuration of the all-solid-state lithium secondary battery.

FIG. 2 is a schematic view showing an example of the all-solid-state lithium secondary battery of the present embodiment. An all-solid-state lithium secondary battery 1000 shown in FIG. 2 has a laminate 100 and an exterior body 200 accommodating the laminate 100. The laminate 100 has a positive electrode 110, a negative electrode 120, and a solid electrolyte layer 130. In addition, the all-solid-state lithium secondary battery 1000 may have a bipolar structure in which CAM and a negative electrode active material are disposed on both sides of a current collector respectively. As specific examples of the bipolar structure, for example, the structure disclosed in JP2004-95400A are exemplary examples. The materials that configures each member will be described below.

The laminate 100 may have an external terminal 113 connected to a positive electrode current collector 112 and an external terminal 123 connected to a negative electrode current collector 122. Other than them, the all-solid-state lithium secondary battery 1000 may have a separator between the positive electrode 110 and the negative electrode 120.

The all-solid-state lithium secondary battery 1000 further has an insulator, not shown, that insulates the laminate 100 and the exterior body 200 from each other, and a sealant, not shown, that seals an opening portion 200a of the exterior body 200.

As the exterior body 200, a container formed by molding a highly corrosion-resistant metal material such as aluminum, stainless steel, or nickel-plated steel can be used. In addition, as the exterior body 200, a container formed by processing a laminate film having at least one surface on which a corrosion resistant process has been performed into a bag shape can be used.

As the shape of the all-solid-state lithium secondary battery 1000, for example, shapes such as a coin type, a button type, a paper type (or sheet type), a cylindrical type, a square type, or a laminate type (pouch type) can be exemplary examples.

Although the all-solid-state lithium secondary battery 1000 is illustrated as having one laminate 100 as an example, the present embodiment is not limited thereto. The all-solid-state lithium secondary battery 1000 may have a configuration in which the laminate 100 is used as a unit cell and a plurality of unit cells (laminate 100) are sealed inside the exterior body 200.

### <4-1. Positive Electrode>

The positive electrode 110 of the present embodiment has a positive electrode active material layer 111 and the positive electrode current collector 112. The positive electrode active material layer 111 contains CAM, which is one aspect of the present invention described above, and solid electrolyte. In addition, the positive electrode active material layer 111 may contain a conductive material and a binder.

### <4-2. Negative Electrode>

The negative electrode 120 has a negative electrode active material layer 121 and the negative electrode current collector 122. The negative electrode active material layer 121 contains a negative electrode active material. In addition, the negative electrode active material layer 121 may contain a solid electrolyte and a conductive material. As the negative electrode active material, the negative electrode current collector, the solid electrolyte, the conductive material, and the binder, those described above can be used.

For the all-solid-state lithium secondary battery, the configuration, the materials, and the production method disclosed in [0151] to [0181] of WO2022/113904A1 can be used, for example.

In the lithium secondary battery configured as described above, since CAM according to the present embodiment described above is used, the cycle characteristic and discharge rate characteristic of the lithium secondary battery using CAM can be improved. In addition, the positive electrode having the above-described configuration has CAM with the aforementioned configuration, and therefore the cycle characteristic and discharge rate characteristic of the lithium secondary battery can be improved. Furthermore, the lithium secondary battery having the above-described configuration has the aforementioned positive electrode and thus becomes a secondary battery having excellent cycle characteristic and discharge rate characteristic.

One embodiment of the present invention includes a method for producing a positive electrode for a lithium secondary battery, the method including a step of obtaining CAM by the aforementioned method for producing CAM, and a step of supporting a positive electrode mixture containing CAM on a positive electrode current collector. In addition, one embodiment of the present invention includes a method for producing a lithium secondary battery, the method including a step of obtaining a positive electrode for a lithium secondary battery by the method for producing a positive electrode for a lithium secondary battery, and a step of disposing an electrolytic solution or solid electrolyte between the positive electrode for a lithium secondary battery and the negative electrode.

The present invention is not limited to the embodiments described above. Various modifications can be made within the scope of the claims, and the technical scope of the present invention also includes embodiments to be obtained by appropriately combining technical means disclosed in different embodiments.

The present invention further includes aspects shown in the following <21> to <35>.

<21> CAM having a layered structure, and containing a particle of LiMO containing at least Li, Ni, and the element X, in which the particle contains a secondary particle which is an aggregate of primary particles and contains a phosphorus element on the surface or on the surface and inside of the secondary particle, and
requirements (1′), (2), and (3′) below are satisfied.
requirement (1′): the value of XPS(P)/XPS(Li) is more than 0 and less than 0.1.
requirement (2): a peak attributed to lithium phosphate is present at 2θ=21 to 250 in the powder X-ray diffraction pattern.
requirement (3′): the amount of lithium eluted is 0.01 to 0.18 wt %.
   <22> CAM according to <21>, in which in the powder X-ray diffraction pattern,
the peak attributed to lithium phosphate contains a peak present at 2θ=22.5±1°, and
H(α) and H(β) satisfy a relationship of 0.010≤H(α)/H(β)≤0.020.
   <23> The positive electrode active material for the lithium secondary battery according to <21> or <22>, in which a molar ratio of Li, Ni, the element X, and the phosphorus element satisfies a formula (1)-1 below.

$$Li : Ni : X : P = a : ( 1 - b ) : b : c \qquad ( 1 ) - 1$$

(In the formula (1), a, b, and c satisfy 0.98≤a≤1.08, 0≤b≤0.3, and 0.01≤c≤0.022.)

<24> CAM according to <23>, in which b in the formula (1) is 0.02 to 0.3.
<25> CAM according to any one of Claims <21> to <24>, in which D₅₀ is 8.0 to 15.0 μm.
<26> CAM according to any one of <21> to <25>, containing a sulfate anion, in which the value of XPS(P)/XPS(S) is 0.50 to 1.50.
<27> CAM according to any one of <21> to <26>, in which the value of XPS(P)/XPS(Li) is 0.01 to 0.08.
<28> A positive electrode for a lithium secondary battery, containing CAM according to any one of <21> to <27>.
<29> A lithium secondary battery containing the positive electrode for the lithium secondary battery according to <28>.
<30> A method for producing CAM, including:
a first mixing step of mixing MCC containing Ni and an element X with a lithium compound to obtain a first mixture;
a first calcining step of calcining the first mixture in an oxygen-containing atmosphere to obtain LiMO;
a second mixing step of mixing LiMO and a phosphate so that a molar ratio of Ni and the element X contained in LiMO and P contained in the phosphate satisfies a formula (2)-1 below to obtain a second mixture,

$$Ni : X : P = ( 1 - b ) : b : c \qquad ( 2 ) - 1$$

(in the formula (2), b and c satisfy 0≤b≤0.3 and 0.01≤c≤0.022); and a second calcining step of calcining the second mixture in an oxygen-containing atmosphere, in which
T₁ is 600 to 730° C., and
T₂ is 700 to 850° C.
   <31> The method for producing CAM according to <30>, in which the second mixture contains 2 to 10 wt % of water relative to the total weight of the second mixture.
   <32> The method for producing CAM according to <10> or <11>, in which the BET specific surface area of the phosphate is 0.15 to 5 m²/g.
   <33> The method for producing CAM according to any one of <30> to <32>, in which
the anionic species of the phosphate is any one selected from the group consisting of PO₄³⁻, HPO₄²⁻, and H₂PO₄⁻, and
the cationic species of the phosphate is one or more selected from the group consisting of Al, Mg, Ca, NH₄, Co, Mn, Ti, and Zr.
   <34> The method for producing CAM according to any one of <30> to <33>, in which a value of T₂−T₁ that is a difference between T₁ and T₂ is 20 to 150° C.
   <35> The method for producing CAM according to any one of <30> to <34>, in which MCC contains 1500 to 7500 ppm of a sulfate anion relative to the total weight of MCC.

### EXAMPLES

An example of the present invention will be described below.

### <X-Ray Photoelectron Spectroscopy (XPS)>

XPS(P), XPS(Li), and XPS(S) were measured using PHI5000 VersaProbe III manufactured by ULVAC-PHI, INC. as an X-ray photoelectron spectrometer. AlKα rays were used as an X-ray source, and a neutralizing gun (acceleration voltage: 0.3 V, current: 100 μA) was used to neutralize the charge during measurement.

As the measurement conditions, the X-ray irradiation diameter was 100 μm, PassEnergy was 120 eV, Step was 0.1 eV, and Dwelltime was 50 ms. For each XPS spectrum obtained, the number of elements of each metal element was calculated from the peak area of each metal element present on the surface of particles in CAM using an analysis software (MultiPak (Version 9.9.0.8)). The charge of the peak attributed to surface-contaminated hydrocarbons in the Cis spectrum was corrected to 284.6 eV.

The abundance ratio [at %] of the element X on the surface of particles in CAM was obtained. Specifically, the ratio of the number of each element to the total value of 100 at % of the number of each element was calculated as the abundance ratio (at %) of the element from each peak other than the peak present at 284.6 eV in a spectrum obtained by XPS measurement.

### Measurement of XPS(P)

The abundance ratio [at %] of the phosphorus element (P) calculated based on the peak area having a peak with a binding energy in the range of 130 to 138 eV in the P2p spectrum was referred to as XPS(P).

### Measurement of XPS(Li)

The abundance ratio [at %] of Li calculated based on the peak area of a peak with a binding energy in the range of 53 to 57 eV in the Li1s spectrum was referred to as XPS(Li).

### Measurement of XPS(S)

The abundance ratio [at %] of the sulfur element (S) derived from sulfate anion calculated based on the peak area in the S2p spectrum was referred to as XPS(S).

### (Compositional Analysis)

After dissolving LiMO or CAM powder in hydrochloric acid, the composition of LiMO or CAM was analyzed using an ICP emission spectrometer (SPS3000 manufactured by Seiko Instruments Inc.). After dissolving MCC powder in hydrochloric acid, the content of sulfate anion in MCC was obtained by converting the value of the content of the sulfur element obtained using the ICP emission spectrometer described above into sulfate anion (SOs).

### <50% Cumulative Volume Particle Diameter D₅₀>

0.1 g of CAM was put into 50 mL of a 0.2 mass % sodium hexametaphosphate aqueous solution, to obtain a dispersion in which CAM was dispersed. Thereafter, the particle size distribution of the dispersion obtained was measured using Microtrac MT3300EXII (laser diffraction scattering particle size distribution measuring device) manufactured by MicrotracBEL Corp. to obtain a volume-based cumulative particle size distribution curve. Then, the value of the particle diameter at the point where the cumulative volume from the fine particle side was 50% when the whole was taken as 100% in the cumulative particle size distribution curve obtained was determined as D₅₀[μm].

### <Powder X-Ray Diffraction Measurement>

CAM obtained in each of Examples and Comparative Examples was subjected to powder X-ray diffraction measurement. In the powder X-ray diffraction pattern obtained, the presence or absence of a peak attributed to lithium phosphate at 2θ=21 to 25° was confirmed. Here, in CAM confirmed to have the peak attributed to lithium phosphate among CAMs obtained in Examples and Comparative Examples, peaks present at 2θ=22.5±1° and 2θ=24.7±1° are included in the peak attributed to lithium phosphate. Thereafter, the height H(α) of the peak present at 2θ=22.5±1°, the height H(γ) of the peak present at 2θ=24.7±1°, and the height H(β) of a peak present at 2θ=18.5±1° were measured among the peaks attributed to lithium phosphate, and the value of H(α)/H(β) and the value of H(γ)/H(β) were calculated based on the measurement results. In addition, the crystal structure of CAM was identified from the powder X-ray diffraction pattern. When the peak with the highest intensity was observed within the range of 2θ=18.7±1°, and a peak with the second highest intensity was observed within the range of 2θ=44.6±1°, it was determined that CAM had a layered structure.

The powder X-ray diffraction measurement was performed using an X-ray diffractometer (UltimaIV manufactured by Rigaku Corporation). Specifically, CAM powder was first filled into a dedicated substrate, and the powder X-ray diffraction measurement was carried out using a Cu-Kα ray source as an X-ray source, to obtain the powder X-ray diffraction pattern. The measurement conditions for the powder X-ray diffraction measurement are as follows.

### (Measurement Conditions)

Diffraction angle: 2θ=100 to 900
Sampling width: 0.02°
Scan speed: 4°/min

### (Production of Positive Electrode)

CAM, a conductive material (acetylene black), and a binder (PVdF) were added and kneaded together at a ratio of composition of CAM:conductive material:binder=92:5:3 (mass ratio), to prepare a positive electrode mixture in paste form. When preparing the positive electrode mixture, N-methyl-2-pyrrolidone was used as an organic solvent.

The positive electrode mixture obtained was applied to an Al foil with a thickness of 40 μm, which was to serve as a current collector, and dried at 150° C. for 8 hours, thereby obtaining a positive electrode. The electrode area of the positive electrode was set to 1.65 cm².

### (Production of Lithium Secondary Battery (Coin-Type Half Cell))

The following operation was performed in a glovebox under an argon atmosphere. The positive electrode produced in the section (Production of positive electrode) was placed on the lower lid of a part of a coin-type battery R2032 part (manufactured by Hohsen Corp.) with the Al foil surface facing downward, and a separator (polyethylene porous film) was placed thereon. 300 μL of an electrolytic solution was poured thereinto. As the electrolytic solution, a solution obtained by dissolving LiPF₆, so as to be 1.0 mol/L, in a liquid mixture of ethylene carbonate, dimethyl carbonate, and ethyl methyl carbonate in 30:35:35 (volume ratio) was used.

As a negative electrode, metal lithium was used. The negative electrode was placed on the upper side of the separator, an upper lid was placed through a gasket further thereon, and they were caulked with a caulking machine, to produce a lithium secondary battery (coin-type half cell R2032). The lithium secondary battery may be hereinafter referred to as “half cell”.

### (Charge/Discharge Test)

Using the half cell produced by the aforementioned method, a discharge rate test and a cycle test were conducted after initial charge/discharge.

### Initial Charge/Discharge

Constant current and constant voltage charging and constant current discharging were performed at a test temperature of 25° C. The current setting value was 0.2 CA for both charging and discharging. The maximum charge voltage was 4.3 V, and the minimum discharge voltage was 2.5 V.

### Discharge Rate Test

After initial charge/discharge, the following constant current and constant voltage charging and constant current discharging were performed at a test temperature of 25° C.
Charging: Constant voltage and constant current charging with a maximum voltage of 4.3 V and a charging current of 0.2 CA
Discharging: Constant current discharging with a minimum voltage of 2.5 V and a discharging current of 0.2 CA or 5 CA

### Discharge Rate Characteristic

The discharge capacity resulting from the constant current discharging at 0.2 CA and the discharge capacity resulting from the constant current discharging at 5 CA were used to determine a 5 CA/0.2 CA discharge capacity ratio, which was obtained by a formula (a) below, and it was regarded as an index for the discharge rate characteristic.

$$( 5 CA / 0.2 CA discharge capacity ratio ) \qquad formula ( a )$$

$$5 CA / 0.2 CA discharge capacity ratio ( \% ) = discharge capacity at 5 CA / discharge capacity at 0.2 CA \times 100$$

### Cycle Test

The cycle test was conducted following the discharge rate test, and the test temperature was set to 25° C. The number of repetitions of the charge/discharge cycle was 50 times. In each cycle, the following constant current and constant voltage charging and constant current discharging were performed.
Charging: Constant voltage and constant current charging with a current setting value of 0.5 CA and a maximum voltage of 4.3 V
Discharging: Constant current discharging with a current setting value of 1 CA and a minimum voltage of 2.5 V

### Cycle Retention Rate

The cycle retention rate was calculated from the discharge capacity at the first cycle and the discharge capacity at the 50th cycle in the cycle test by a formula (b) below.

$$Cycle retention rate [ \% ] = discharge capacity [ mAh / g ] at \\ {50}^{th} cycle / discharge capactiy [ mAh / g ] at first cycle \times 100 \qquad formula ( b )$$

A higher cycle retention rate is desirable for battery performance because decrease in the capacity of the battery after repeated charge/discharge is suppressed. Furthermore, the higher the cycle retention rate, the better the cycle characteristic.

### <Amount of Lithium Eluted>

5 g of CAM and 100 g of pure water were put into a 100 mL polypropylene container, to form a slurry. A stirring bar was put into the slurry, and the container was sealed, followed by stirring for 5 minutes. After stirring, the slurry was filtered, and 0.1 mol/L hydrochloric acid was continuously added dropwise to 60 g of the filtrate obtained by filtration, using an automatic titrator (AT-610 manufactured by Kyoto Electronics Manufacturing Co., Ltd.) to a pH of 4.0. The pH of the filtrate was measured in a pH meter. The titration of hydrochloric acid at pH=8.3±0.1 was referred to as A [mL], and the titration of hydrochloric acid at pH=4.5±0.1 was referred to as B [mL]. Then, the lithium carbonate concentration and the lithium hydroxide concentration eluted from CAM were calculated respectively from formulas (c) and (d) below. In the formulas below, the molecular weights of lithium carbonate and lithium hydroxide were calculated, assuming that the respective atomic weights were H:1.000, Li:6.941, C:12, and O:16.

$$Lithium carbonate concentration [ wt \% ] = \{ 0.1 \times ( B - A ) / 1000 \} \times \{ 73.882 / ( 20 \times 60 / 100 ) \} \times 100 \qquad formula ( c )$$

$$Lithium hydroxide concentration [ wt \% ] = \{ 0.1 \times ( 2 A - B ) / 1000 \} \times \{ 23.941 / ( 20 \times 60 / 100 ) \} \times 100 \qquad formula ( d )$$

From the lithium carbonate concentration and the lithium hydroxide concentration calculated, the amount of lithium eluted was calculated by a formula (e) below.

$$Amount of lithium eluted [ wt \% ] - lithium carbonate concentration \times ( 2 \times 6.941 / 73.882 ) + lithium hydroxide concentration \times ( 6.941 / 23.941 ) \qquad formula ( e )$$

### Example 1

### (First Mixing Step)

A metal composite hydroxide 1 represented by the compositional formula Ni_{0.96}Co_{0.02}Mn_{0.02}(OH)₂ obtained by a known coprecipitation method and lithium hydroxide monohydrate were mixed so that the molar ratio Li/(Ni+Co+Mn) of the amount of Li to the total amount 1 of Ni, Co, and Mn contained in the metal composite hydroxide 1 was 1.03, to obtain a mixture M1-1. The metal composite hydroxide 1 which was MCC contained 4000 ppm of a sulfate anion as an impurity in ICP elemental analysis.

### (First Calcining Step)

Then, the mixture M1-1 obtained was filled into a sagger, and it was calcined in a calcination furnace at 700° C. for 5 hours while a pure oxygen gas was passed therethrough. The calcined product obtained was crushed to obtain a calcined product C1-1. The calcined product C1-1 which was LiMO had m=0.015, n=0.04, X═Co, and Mn corresponding to the compositional formula (I) as a result of ICP elemental analysis.

### (Second Mixing Step)

The powder of the calcined product C1-1 and aluminum phosphate (AlPO₄) having a BET specific surface area of 2.4 m²/g were mixed for 5 minutes so that Ni, Co, and Mn contained in the calcined product C1-1 and P in the AlPO₄ satisfied Ni:(Co+Mn):P=0.96:0.04:0.015. Pure water was further added thereto and mixed for 5 minutes to obtain a mixture M2-1 by the second mixing step. The mixture M2-1 contained 10.2 wt % of water.

### (Second Calcining Step)

The mixture M2-1 was filled into the sagger, and it was calcined in a calcination furnace at 740° C. for 5 hours while a pure oxygen gas was passed therethrough. The calcined product obtained after calcination was crushed to obtain CAM-1.

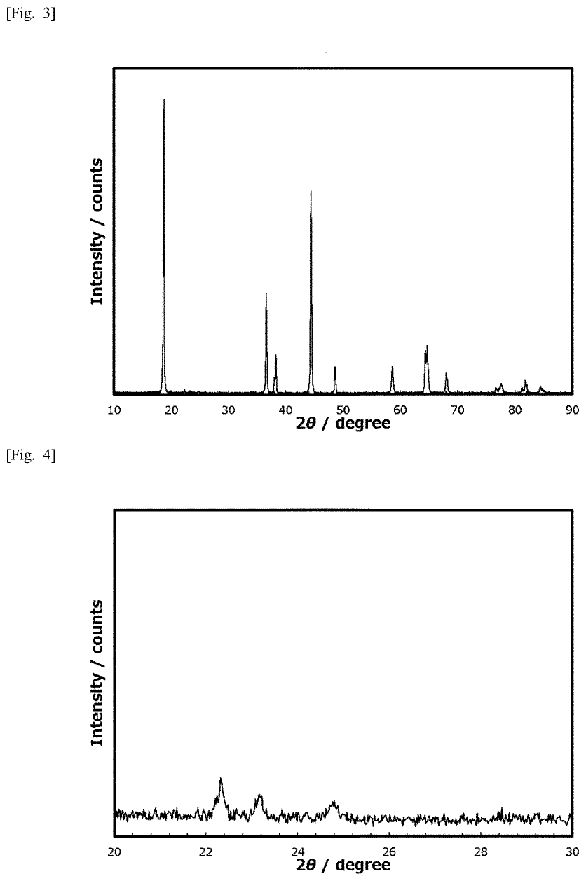

CAM-1 had a layered structure and satisfied Li:Ni:X:P=1.00:0.93:0.07:0.015 by ICP elemental analysis. In addition, the 50% cumulative volume particle diameter D₅₀ of CAM-1 was 9.4 μm, XPS(S) was 0.73 at %, XPS(P) was 0.81 at %, and XPS(Li) was 26.0 at %. As a result of carrying out powder X-ray diffraction targeting CAM-1, a peak attributed to lithium phosphate was confirmed at 2θ=21 to 250 in the powder X-ray diffraction pattern obtained. As a result, CAM-1 was found to contain a phosphorus element on the surface and inside of secondary particles of LiMO. FIGS. 3 and 4 each show a XRD profile obtained by the powder X-ray diffraction targeting CAM-1.

### Example 2

A mixture M2-2 was obtained by the same method as in Example 1 except that in the second mixing step, magnesium hydrogen phosphate trihydrate (MgHPO₄·3H₂O) was mixed instead of the aluminum phosphate with the powder of the calcined product C1-1 so that Ni, Co, and Mn contained in the calcined product C1-1 and P in the MgHPO₄·3H₂O satisfied Ni:(Co+Mn):P=0.96:0.04:0.022. The mixture M2-2 contained 7.7 wt % of water. CAM-2 was obtained by the same method as in Example 1 except that the mixture M2-2 was used instead of the mixture M2-1. In addition, the BET specific surface area of the magnesium hydrogen phosphate trihydrate was 0.50 m²/g.

CAM-2 had a layered structure and satisfied Li:Ni:X:P=1.00:0.92:0.08:0.021 by ICP elemental analysis. In addition, the 50% cumulative volume particle diameter D₅₀ of CAM-2 was 9.4 μm, XPS(S) was 0.77 at %, XPS(P) was 0.46 at %, and XPS(Li) was 25.91 at %. As a result of carrying out powder X-ray diffraction targeting CAM-2, a peak attributed to lithium phosphate was confirmed at 2θ=21 to 250 in the powder X-ray diffraction pattern obtained. As a result, CAM-2 was found to contain a phosphorus element on the surface and inside of secondary particles of LiMO.

### Example 3

A mixture M2-3 was obtained by the same method as in Example 1 except that in the second mixing step, the aluminum phosphate was mixed with the powder of the calcined product C1-1 so that Ni, Co, and Mn contained in the calcined product C1-1 and P in the AlPO₄ satisfied Ni:(Co+Mn):P=0.96:0.04:0.020; and no pure water was added. CAM-3 was obtained by the same method as in Example 1 except that the mixture M2-3 was used instead of the mixture M2-1.

CAM-3 had a layered structure and satisfied Li:Ni:X:P=1.00:0.92:0.08:0.021 by ICP elemental analysis. In addition, the 50% cumulative volume particle diameter D₅₀ of CAM-3 was 9.3 μm, XPS(S) was 0.91 at %, XPS(P) was 0.89 at %, and XPS(Li) was 27.08 at %. As a result of carrying out powder X-ray diffraction targeting CAM-3, a peak attributed to lithium phosphate was confirmed at 2θ=21 to 25° in the powder X-ray diffraction pattern obtained. As a result, CAM-3 was found to contain a phosphorus element on the surface and inside of secondary particles of LiMO.

### Comparative Example 1

CAM-4 was obtained by carrying out calcination and crushing by the same method as in the second calcining step targeting only the calcined product C1-1, without performing the second mixing step.

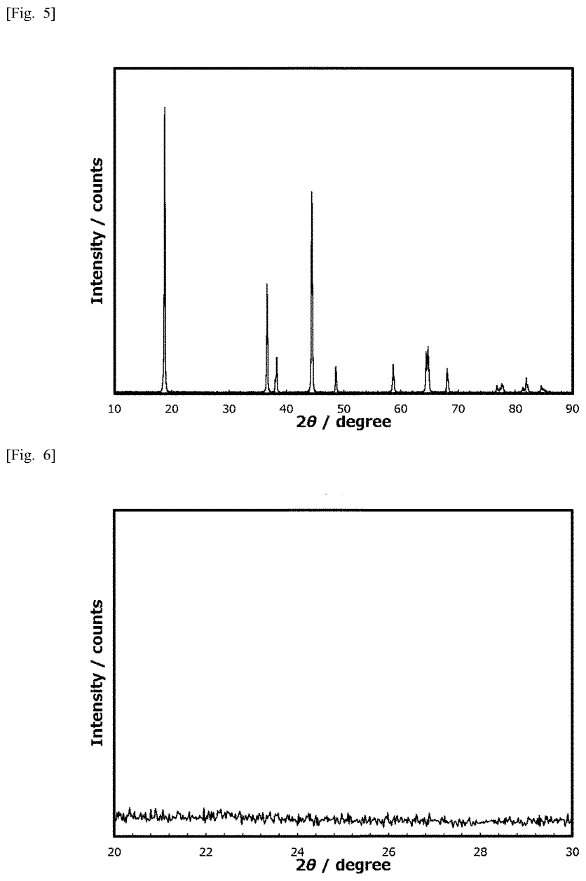

CAM-4 had a layered structure and satisfied Li:Ni:X:P=1.03:0.96:0.04:0.000 by ICP elemental analysis. In addition, the 50% cumulative volume particle diameter D₅₀ of CAM-4 was 9.9 μm, XPS(S) was 1.21 at %, XPS(P) was 0 at %, and XPS(Li) was 27.1 at %. As a result of carrying out powder X-ray diffraction targeting CAM-4, no peak attributed to lithium phosphate was confirmed in the powder X-ray diffraction pattern obtained. As a result, CAM-4 was found to contain no phosphorus element on the surface and inside of secondary particles of LiMO. FIGS. 5 and 6 each show a XRD profile obtained by the powder X-ray diffraction targeting CAM-4.

### Comparative Example 2

The metal composite hydroxide 1 and lithium hydroxide monohydrate were mixed so that the molar ratio Li/(Ni+Co+Mn) of the amount of Li to the total amount 1 of Ni, Co, and Mn contained in the metal composite hydroxide 1 was 1.12, to obtain a mixture M1-2. The mixture M1-2 was calcined at a calcining temperature of 720° C. After calcination, crushing was carried out to obtain a calcined product C1-2.

The calcined product C1-2 and pure water were mixed so that the weight of the calcined product C1-2 became 30 wt % of the whole, and the resulting slurry was stirred for 10 minutes and then filtered to obtain wet cake. The wet cake was calcined at a calcining temperature of 650° C. in the air for 5 hours. After calcination, crushing was carried out to obtain CAM-5.

CAM-5 had a layered structure and satisfied Li:Ni:X:P=1.03:0.96:0.04:0.000 by ICP elemental analysis. In addition, the 50% cumulative volume particle diameter D₅₀ of CAM-5 was 11.2 μm, XPS(S) was 0.54 at %, XPS(P) was 0 at %, and XPS(Li) was 20.84 at %. As a result of carrying out powder X-ray diffraction targeting CAM-5, no peak attributed to lithium phosphate was confirmed in the powder X-ray diffraction pattern obtained. As a result, CAM-5 was found to contain no phosphorus element on the surface and inside of secondary particles of LiMO.

### Comparative Example 3

CAM-6 was obtained by carrying out the same method as in Example 2 except that in the second calcining step, the calcining temperature was set to 220° C., and the oxygen-containing atmosphere during calcination was changed to the air.

CAM-6 had a layered structure and satisfied Li:Ni:X:P=1.00:0.92:0.08:0.021 by ICP elemental analysis. In addition, the 50% cumulative volume particle diameter D₅₀ of CAM-6 was 9.5 μm, XPS(S) was 1.18 at %, XPS(P) was 4.64 at %, and XPS(Li) was 26.07 at %. As a result of carrying out powder X-ray diffraction targeting CAM-6, no peak attributed to lithium phosphate was confirmed in the powder X-ray diffraction pattern obtained. As a result, CAM-6 was found to contain no phosphorus element on the surface and inside of secondary particles of LiMO.

### Comparative Example 4

A mixture M1-3 was obtained by the same method as in the first mixing step of Example 1 except that additional lithium phosphate (Li₃PO₄) having a BET specific surface area of 25.1 m²/g was added so that Ni, Co, and Mn contained in the metal composite hydroxide 1 and P in the Li₃PO₄ satisfied Ni:(Co+Mn):P=0.96:0.04:0.020.

CAM-7 was obtained by carrying out the calcination and crushing of the mixture M1-3 by the same method as in the first calcining step of Example 1 except that the calcining temperature was changed to 740° C.

CAM-7 had a layered structure and satisfied Li:Ni:X:P=1.06:0.94:0.06:0.019 by ICP elemental analysis. In addition, the 50% cumulative volume particle diameter D₅₀ of CAM-7 was 9.5 μm, XPS(S) was 0.61 at %, XPS(P) was 0.64 at %, and XPS(Li) was 28.55 at %. As a result of carrying out powder X-ray diffraction targeting CAM-7, a peak attributed to lithium phosphate was confirmed at 2θ=21 to 250 in the powder X-ray diffraction pattern obtained. As a result, CAM-7 was found to contain a phosphorus element on the surface and inside of secondary particles of LiMO.

### Example 4

### (Preparation of Precursor Material)

After water was poured into a reaction vessel equipped with a stirrer and an overflow pipe, a sodium hydroxide aqueous solution was added, and the liquid temperature was held at 50° C.

A nickel sulfate aqueous solution and a cobalt sulfate aqueous solution were mixed together so that a molar ratio of Ni and Co is 0.88:0.09, to prepare a mixed raw material solution. Furthermore, an aluminum sulfate aqueous solution was prepared as a raw material solution containing Al.

Then, the mixed raw material solution and the aluminum sulfate aqueous solution were continuously added into the reaction vessel under stirring so that a molar ratio of Ni, Co, and Al is 0.88:0.09:0.03, and an ammonium sulfate aqueous solution was continuously added as a complexing agent. A sodium hydroxide aqueous solution was timely added dropwise so that the pH in the reaction vessel was 11.7 (measurement temperature: 40° C.), to obtain a reaction precipitate.

The reaction precipitate was washed, then dehydrated, dried, and classified, to obtain a metal composite hydroxide 2 containing Ni, Co, and Al.

### (First Mixing Step)

The metal composite hydroxide 2 was calcined in a calcination furnace at 650° C. for 5 hours to obtain a metal composite oxide 1. The metal composite oxide 1 and lithium hydroxide monohydrate were mixed so that the molar ratio Li/(Ni+Co+Al) of the amount of Li to the total amount 1 of Ni, Co, and Al contained in the metal composite oxide 1 was 1.00, to obtain a mixture M1-4. The metal composite hydroxide 2 which was MCC contained 4000 ppm of a sulfate anion in ICP elemental analysis.

### (First Calcining Step)

Then, the mixture M1-4 obtained was filled into a sagger, and it was calcined in a calcination furnace at 650° C. for 5 hours while a pure oxygen gas was passed therethrough. The calcined product obtained was crushed to obtain a calcined product C1-3. The calcined product C1-3 which was LiMO had m=0.00, n=0.12, X═Co, and Al corresponding to the compositional formula (I) as a result of ICP elemental analysis.

### (Second Mixing Step)

The powder of the calcined product C1-3 and magnesium hydrogen phosphate trihydrate having a BET specific surface area of 0.50 m²/g were mixed for 5 minutes so that Ni, Co, and Al contained in the calcined product C1-3 and P in the MgHPO₄·3H₂O satisfied Ni:(Co+Al):P=0.88:0.12:0.021. Pure water was further added thereto and mixed for 5 minutes to obtain a mixture M2-4 by the second mixing step. The mixture M2-4 contained 10.2 wt % of water.

### (Second Calcining Step)

The mixture M2-4 was filled into the sagger, and it was calcined in a calcination furnace at a calcining temperature of 780° C. for 5 hours while a pure oxygen gas was passed therethrough. The calcined product obtained after calcination was crushed to obtain CAM-8.

CAM-8 had a layered structure and satisfied Li:Ni:X:P=0.98:0.84:0.16:0.022 by ICP elemental analysis. In addition, the 50% cumulative volume particle diameter D₅₀ of CAM-8 was 14.8 μm, XPS(S) was 0.70 at %, XPS(P) was 0.62 at %, and XPS(Li) was 23.46 at %. As a result of carrying out powder X-ray diffraction targeting CAM-8, a peak attributed to lithium phosphate was confirmed at 2θ=21 to 250 in the powder X-ray diffraction pattern obtained. As a result, CAM-8 was found to contain a phosphorus element on the surface and inside of secondary particles of LiMO.

### Comparative Example 5

The powder of the calcined product C1-3 obtained in the course of Example 4 and pure water were mixed so that the weight of the calcined product C1-3 became 60 wt % of the whole, and the resulting slurry was stirred for 10 minutes and then filtered to obtain wet cake. The wet cake had a water content of 10.7 wt %. The wet cake was calcined in a calcination furnace at a calcining temperature of 780° C. for 5 hours while a pure oxygen gas was passed therethrough. The calcined product obtained after calcination was crushed to obtain CAM-9.

CAM-9 had a layered structure and satisfied Li:Ni:M:P=0.95:0.88:0.12:0.000 by ICP elemental analysis, and XPS(S) was 0.60 at %. In addition, the 50% cumulative volume particle diameter D₅₀ of CAM-9 was 12.2 μm, XPS(P) was 0 at %, and XPS(Li) was 26.81 at %. As a result of carrying out powder X-ray diffraction targeting CAM-9, no peak attributed to lithium phosphate was confirmed at 2θ=21 to 25° in the powder X-ray diffraction pattern obtained. As a result, CAM-9 was found to contain no phosphorus element on the surface and inside of secondary particles of LiMO.

### Results

The physical properties and the like of CAM-1 to CAM-9 produced in Examples 1 to 4 and Comparative Examples 1 to 5 were measured by the aforementioned methods. The results are shown in Tables 1 and 2 below. In addition, “lithium phosphate peak” refers to a peak attributed to lithium phosphate, which is present at 2θ=21 to 25°, in the powder X-ray diffraction pattern obtained by powder X-ray diffraction measurement.

TABLE 1

| | Example 1 | Example 2 | Example 3 | Example 4 |
|---|---|---|---|---|
| Composition of LiMO | Ni/Co/Mn = 96/2/2 | Ni/Co/Mn = 96/2/2 | Ni/Co/Mn = 96/2/2 | Ni/Co/Al = 88/9/3 |
| Phosphate | AlPO₄ | MgHPO₄ • 3H₂O | AlPO₄ | MgHPO₄ • 3H₂O |
| Mixing | During second | During second | During second | During second |
| | mixing step | mixing step | mixing step | mixing step |
| | Wet mixing | Wet mixing | Dry mixing | Wet mixing |
| T₁ | 700° C. | 700° C. | 700° C. | 650° C. |
| T₂ | 740° C. | 740° C. | 740° C. | 780° C. |
| XPS(P)/XPS(Li) | 0.031 | 0.018 | 0.033 | 0.026 |
| Presence or absence of | Present | Present | Present | Present |
| lithium phosphate peak | | | | |
| H(α)/H(β) | 0.011 | 0.012 | 0.014 | 0.019 |
| H(γ)/H(β) | 0.0049 | 0.0069 | 0.0082 | 0.0107 |
| XPS(P)/XPS(S) | 1.11 | 0.60 | 0.98 | 0.89 |
| D₅₀ [μm] | 9.4 | 9.4 | 9.3 | 14.8 |
| Amount of lithium | 0.17 | 0.18 | 0.15 | 0.15 |
| eluted [wt %] | | | | |
| Discharge rate capacity | 37.6 | 41.1 | 39.4 | 34.7 |
| ratio(5 C/0.2 C) | | | | |
| [%] | | | | |
| Cycle retention rate [%] | 82.4 | 77.9 | 84.9 | 94.5 |

TABLE 2

| | Comparative | Comparative | Comparative | Comparative | Comparative |
|---|---|---|---|---|---|
| | Example 1 | Example 2 | Example 3 | Example 4 | Example 5 |
| Composition of | Ni/Co/Mn = 96/2/2 | Ni/Co/Mn = 96/2/2 | Ni/Co/Mn = 96/2/2 | Ni/Co/Mn = 96/2/2 | Ni/Co/Al = 88/9/3 |
| LiMO | | | | | |
| Phosphate | — | — | MgHPO₄ • 3H₂O | LiPO₄ | — |
| Mixing | — | — | During second | During first | — |
| | | | mixing step | mixing step | |
| | — | — | Wet mixing | Dry mixing | — |
| T₁ | 700° C. | 720° C. | 700° C. | 740° C. | 650° C. |
| T₂ | 740° C. | 650° C. | 220° C. | — | 780° C. |
| XPS(P)/XPS(Li) | 0 | 0 | 0.178 | 0.022 | 0 |
| Presence or absence | Absent | Absent | Absent | Present | Absent |
| of lithium phosphate | | | | | |
| peak | | | | | |
| H(α)/H(β) | 0 | 0 | 0 | 0.012 | 0 |
| H(γ)/H(β) | 0 | 0 | 0 | 0.060 | 0 |
| XPS(P)/XPS(S) | 0 | 0 | 3.93 | 1.05 | 0 |
| D₅₀ [μm] | 9.9 | 11.2 | 9.5 | 9.5 | 12.2 |
| Amount of lithium | 0.23 | 0.19 | 0.20 | 0.20 | 0.10 |
| eluted [wt %] | | | | | |
| Discharge rate | 30.7 | 38.3 | 30.2 | 33.2 | 31.4 |
| capacity ratio | | | | | |
| (5 C/0.2 C) | | | | | |
| [%] | | | | | |
| Cycle retention rate | 76.9 | 75.4 | 80.5 | 79.8 | 83.4 |
| [%] | | | | | |

The methods for producing CAM described in Examples 1 to 4 correspond to the method for producing CAM according to an embodiment of the present invention. As described in Table 1, CAMs produced by the methods for producing CAM described in Examples 1 to 4 satisfy the requirements (1), (2), and (3).

On the other hand, the methods for producing CAM described in Comparative Examples 1 to 5 do not correspond to the method for producing CAM according to an embodiment of the present invention. As described in Table 2, CAMs produced by the methods for producing CAM described in Comparative Examples 1 to 5 do not satisfy at least one of the requirements (1), (2), and (3).

From these results, it was found that CAM which satisfies the requirements (1), (2), and (3) according to an embodiment of the present invention in can be produced by the method for producing CAM according to an embodiment of the present invention.

As described in Tables 1 and 2, lithium secondary batteries produced using CAMs described in Examples 1 to 4 are found superior in cycle characteristics and discharge rate characteristics to lithium secondary batteries produced using CAMs described in Comparative Examples 1 to 5. Thus, it can be understood that CAM according to an embodiment of the present invention has the effect that it can improve the cycle characteristics and discharge rate characteristics of the lithium secondary battery. In addition, it can be understood that the method for producing CAM according to an embodiment of the present invention has the effect that it can produce CAM that can improve the cycle characteristic and discharge rate characteristic of the lithium secondary battery.

### INDUSTRIAL APPLICABILITY

An embodiment of the present invention can be utilized in the production of a lithium secondary battery excellent in cycle characteristic and discharge rate characteristic.

### REFERENCE SIGNS LIST

1: Separator
2: Positive electrode
3: Negative electrode
4: Electrode group
5: Battery can
6: Electrolytic solution
7: Top insulator
8: Sealing body
10: Lithium secondary battery
21: Positive electrode lead
31: Negative electrode lead
100: Laminate
110: Positive electrode
111: Positive electrode active material layer
112: Positive electrode current collector
113: External terminal
120: Negative electrode
121: Negative electrode active material layer
122: Negative electrode current collector
123: External terminal
130: Solid electrolyte layer
200: Exterior body
200a: Opening portion
1000: All-solid-state lithium secondary battery

1. A positive electrode active material for a lithium secondary battery having a layered structure, comprising a particle of a lithium metal composite oxide containing at least Li, Ni, and an element X,
wherein the particle comprises a secondary particle which is an aggregate of primary particles and comprises a phosphorus element on the surface or on the surface and inside of the secondary particle,
the element X is one or more elements selected from the group consisting of Co, Mn, Fe, Cu, Ti, Mg, Ca, Al, W, Mo, Nb, Zn, Sn, Zr, Ga, V, B, and Si, and,
requirements (1), (2), and (3) below are satisfied,
requirement (1): a value of XPS(P)/XPS(Li) is more than 0 and 0.15 or less (here, XPS(P) represents an abundance ratio [at %] of the phosphorus element obtained from a P2p spectrum measured by X-ray photoelectron spectroscopy, and XPS(Li) represents an abundance ratio [at %] of Li obtained from a Li1s spectrum measured by X-ray photoelectron spectroscopy);
requirement (2): a peak attributed to lithium phosphate is present at 2θ=21 to 250 in a powder X-ray diffraction pattern obtained by powder X-ray diffraction measurement; and
requirement (3): an amount of lithium eluted obtained by a neutralization titration method is less than 0.20 wt %.

2. The positive electrode active material for the lithium secondary battery according to claim 1,
wherein in the powder X-ray diffraction pattern, the peak attributed to lithium phosphate comprises a peak present at 2θ=22.5±1, and
a height H(α) of the peak present at 2θ=22.5±1 and a height H(β) of a peak present at 2θ=18.5±1° satisfy a relationship of 0.003≤H(α)/H(β)≤0.03.

3. The positive electrode active material for the lithium secondary battery according to claim 1,
wherein a molar ratio of Li, Ni, the element X, and the phosphorus element satisfies a formula (1) below,
$$Li : Ni : X : P = a : ( 1 - b ) : b : c \qquad ( 1 )$$
(in the formula (1), a, b, and c satisfy 0.90≤a≤1.2, 0≤b≤0.7, and 0.003≤c≤0.03.)

4. The positive electrode active material for the lithium secondary battery according to claim 3,
wherein b in the formula (1) is 0 or more and 0.3 or less.

5. The positive electrode active material for the lithium secondary battery according to claim 1,
wherein a 50% cumulative volume particle diameter D₅₀ is 5 μm or more and 20 μm or less.

6. The positive electrode active material for the lithium secondary battery according to claim 1, comprising a sulfate anion,
wherein a value of XPS(P)/XPS(S) is more than 0 and 2.0 or less
(here, XPS(P) represents an abundance ratio [at %] of the phosphorus element, and XPS(S) represents an abundance ratio [at %] of the sulfur element obtained from a S2p spectrum measured by X-ray photoelectron spectroscopy.)

7. The positive electrode active material for the lithium secondary battery according to claim 1,
wherein the value of XPS(P)/XPS(Li) is more than 0 and less than 0.1.

8. A positive electrode for a lithium secondary battery, comprising:
the positive electrode active material for the lithium secondary battery according to claim 1.

9. A lithium secondary battery comprising:
the positive electrode for the lithium secondary battery according to claim 8.

10. A method for producing a positive electrode active material for a lithium secondary battery, comprising:
a first mixing step of mixing a metal composite compound comprising Ni and an element X with a lithium compound to obtain a first mixture;
a first calcining step of calcining the first mixture in an oxygen-containing atmosphere to obtain a lithium metal composite oxide;
a second mixing step of mixing the lithium metal composite oxide and a phosphate so that a molar ratio of Ni and the element X contained in the lithium metal composite oxide and a phosphorus element contained in the phosphate satisfies a formula (2) below to obtain a second mixture,
$$Ni : X : P = ( 1 - b ) : b : c \qquad ( 2 )$$
(in the formula (2), b and c satisfy 0≤b≤0.7 and 0.003≤c≤0.03); and
a second calcining step of calcining the second mixture in an oxygen-containing atmosphere,
wherein the element X is one or more elements selected from the group consisting of Co, Mn, Fe, Cu, Ti, Mg, Ca, Al, W, Mo, Nb, Zn, Sn, Zr, Ga, V, B, and Si,
a highest holding temperature T₁ in the first calcining step is 500° C. or more and 750° C. or less, and
a highest holding temperature T₂ in the second calcining step is 650° C. or more and 900° C. or less.

11. The method for producing the positive electrode active material for the lithium secondary battery according to claim 10,
wherein the second mixture contains 1 wt % or more and 15 wt % or less of water relative to the total weight of the second mixture.

12. The method for producing the positive electrode active material for the lithium secondary battery according to claim 10,
wherein a BET specific surface area of the phosphate is 0.1 m²/g or more and 10 m²/g or less.

13. The method for producing the positive electrode active material for the lithium secondary battery according to claim 10,
wherein an anionic species of the phosphate is any one selected from the group consisting of PO₄³⁻, HPO₄²⁻, and H₂PO₄⁻, and
a cationic species of the phosphate is one or more selected from the group consisting of Al, Mg, Ca, NH₄, Co, Mn, Ti, and Zr.

14. The method for producing the positive electrode active material for the lithium secondary battery according to claim 10,
wherein a condition that a value of T₂−T₁ that is a difference between the highest holding temperature T₁ in the first calcining step and the highest holding temperature T₂ in the second calcining step is 20° C. or more and 250° C. or less, is satisfied.

15. The method for producing the positive electrode active material for the lithium secondary battery according to claim 10,
wherein the metal composite compound comprises 500 ppm or more and 10000 ppm or less of a sulfate anion relative to the total weight of the metal composite compound.
